(19) United States
(12) Patent Application Publication
(10) Pub. No.: US 2009/0115096 A1
(43) Pub. Date: May 7, 2009

(54) PRODUCTION METHOD OF POLYMER FILM

(75) Inventors: Koju Ito, Kanagawa (JP); Hidekazu Yamazaki, Kanagawa (JP); Yoshiaki Narukawa, Kanagawa (JP); Hiromasa Tanaka, Kanagawa (JP)

Correspondence Address: YOUNG & THOMPSON, 209 Madison Street, Suite 500, ALEXANDRIA, VA, 22314, US

(73) Assignee: FUJIFILM CORPORATION, Tokyo (JP)

(21) Appl. No.: 12/294,052

(22) PCT Filed: Mar. 20, 2007
(86) PCT No.: PCT/JP2007/056511

§ 371 Date: Sep. 23, 2008

(30) Foreign Application Priority Data
Mar. 23, 2006 (JP) 2006-080360

(51) Int. Cl. B29C 55/02

(52) U.S. Cl. 264/241

(57) ABSTRACT

A primary dope is obtained by mixing solvent and polymer, and an additive is added to the primary dope so as to prepare three sorts of dopes. The dopes are cast from a casting die onto a casting belt to form three-layer film. The thickness of the first layer t1 is the same as the thickness of the third layer t3 or less, and the thickness of the third layer t3 is the same as the thickness of the second layer t2 or less. After the film is peeled from the casting belt, both side edge portions of the film are clipped by clips. The film is stretched in a widthwise direction and dried. The film is excellent in smoothness and optical properties.

### TECHNICAL FIELD

The present invention relates to a production method of a polymer film to be adequately used as an optical film in a liquid crystal display.

### BACKGROUND ART

A polymer film is widely used, for example, as a protective film of a polarizing filter of a liquid crystal display for protecting the polarized film, a wide view film and the like, since having merits in high transparency, high workability, handling easiness, smallness, possibility of miniaturization and the like. Especially, a cellulose acylate film produced by using a cellulose acylate or a cyclic polyolefin as a polymer is reasonable and excellent in optical properties (such as wide view angle, high transmittance and the like) and reasonable cost of raw materials. Therefore, attention is focused on the cellulose acylate film with high functions that is produced at low cost.

In order to produce the polymer film, a solution casting method is mainly used. In the solution casting method, a dope is prepared by mixing a polymer (such as the cellulose acylate, the cyclic polyolefin and the like) as the raw material of the film, an organic solvent and the like, and cast thereafter onto a running support to form thereon a casting film containing the solvent. Then the casting film is peeled as a wet film from the support. The wet film, which contains the solvent, is dried to the polymer film.

In recent years, it is required to improve the technology of producing a cellulose acylate film excellent in planarity by a solution casting method with high productivity. In the solution casting method, therefore, several arrangements are made so as to produce the film with high productivity. For example, in order to make the production speed higher, the casting film is dried by applying a drying air and so on, so as to have a self-supporting property. Thus the casting film is stably peeled from the support, and therefore the productivity becomes higher. Further, the drying speed of the casting film is made higher such that the production time may be shorter. Thus the productivity becomes higher. However, if the blowing direction of the drying air is varied so as to increase the drying speed, the unevenness occurs on the casting film, and therefore the planarity of the produced polymer film becomes lower.

In order to produce the polymer film excellent in planarity, there are a co-casting method in which at least two sorts of dopes with different viscosities are cast to form on the support a casting film having a multi-layer structure. In this case, it is already known that a main layer between the support and an uppermost layer (or exposure layer) of the casting film is formed from a layer of high viscosity. The exposure layer is formed from a dope of low viscosity and therefore the surface tension increases the leveling effect for making the film surface. Thus the produced polymer film is excellent in the planarity while the occurrence of the unevenness is prevented.

For example, the Japanese Patent Laid-Open Publication No. 2003-276037 teaches a production method of the casting film of a multilayer structure having a main layer made of a dope of high viscosity (in the range of 30 Pa·s to 60 Pa·s) and an exposure layer made of a dope of low viscosity (20 Pa·s). In 20 seconds after the co-casting, a drying air at 10 m/sec. or more is applied to the casting film.

However, in the production method of this Laid-Open publication, the forming of the exposure layer from the dope of low viscosity is not enough to reduce the generation of unevenness on the surface of the casting layer. Therefore, the produced film hardly has the level of the planarity that is required in recent years. Further, when the casting film is peeled from the support, the peelability becomes lower and therefore part of the casting film remains on the support. In this case, the productivity is continuously low, and further, the remaining part contacts to the surface of the casting film, the planarity becomes lower.

An object of the present invention is to provide a production method of a polymer film excellent in smoothness by drying a casting film without occurrence of the thickness unevenness.

Another object of the present invention is to provide a production method of a polymer film in high productivity by increasing a peelability, namely an easiness for peeling a casting film from a support.

### DISCLOSURE OF INVENTION

In order to achieve the object and the other object, in a production method of a polymer film, an additive is added to a primary dope as a mixture of a polymer and an organic solvent so as to prepare three sorts of dopes, and the dopes are cast on a moving support as to form a casting film having three layers superimposed. The three layers are a first layer of thickness t1 (μm), a second layer of thickness t2 (μm) and an third layer of thickness t3 (μm), at least one of said thickness t1, t2 and t3 being different, and a condition t1≦t3≦t2 is satisfied.

The casting film is peeled from the support as a wet film containing the organic solvent. Both side edge portions of the wet film is clipped by a clipping member. The wet film is stretched in a widthwise direction by moving the clipping member, and dried during the stretching such that the polymer film may be obtained.

Preferably a percentage of a thickness t3 of the third layer to a total thickness of the casting film is in the range of 3% to 40%.

Preferably, the dopes for forming the first-third layers are respectively a first dope, a second dope and a third dope, and a condition η3≦η1≦η2 is satisfied if viscosities of the first, second and third dopes are respectively described as η1 (Pa·s), η2 (Pa·s) and η3 (Pa·s).

Preferably the polymer is a cellulose acylate whose polymerization degree is in the range of 250 and 450. Particularly, the viscosity η3 of the third dope satisfies 5 Pa·s≦η3≦30 Pa·s.

Preferably a mass A (g) of solid compound contained in the third dope and a mass B (g) of the organic solvent satisfy a formula, 16≦[(A−B)/A]×100≦21.

Preferably, the primary dope is fed in a pipe, and the additive is added to the primary dope through a tube connected to the pipe. The primary dope and the additive is stirred by a static mixer provided in the pipe. Particularly preferably, the tube includes at an end thereof a slit outlet extending in a diameter direction of the pipe. Especially preferably, a length of the slit is in the range of 20% to 80% of an inner diameter of the pipe. Further, especially preferably, a clearance C of the slit is at least 0.1 mm and at most one tenth of an inner diameter of the pipe. Especially preferably, furthermore, a distance D from the additive to the inline mixer is in the range of 1 mm to 250 mm. Further, a current speed V1 of the additive flowing in the tube and a current speed V2 of the primary dope flowing in the pipe satisfy a condition, 1≦V1/V2≦5.

Preferably, the casting is a co-casting or a sequential casting.

According to the present invention, the casting film is dried without occurrence of the thickness unevenness. Further, the peelability, namely the easiness of peeling of the casting film from the support becomes higher, and therefore the produced polymer film is excellent in the planarity while the decrease of the quality is prevented and the productivity is increased.

### BRIEF DESCRIPTION OF DRAWINGS

FIG. 1 is a schematic diagram of a dope preparation line;

FIG. 2 is an explanatory view of an example of adding an additive to a primary dope with use of a static mixer;

FIG. 3 is a perspective view of a nozzle for adding the additive, illustrating a situation in a pipe in which the primary dope flows;

FIG. 4 is a front view of an outlet of the nozzle in the pipe;

FIG. 5 is a schematic diagram of a film production line of the present invention;

FIG. 6 is a schematic diagram illustrating a situation of the casting of a casting dope from a die in the film production line;

FIG. 7 is a schematic diagram of an embodiment of a sequential casting method according to the present invention.

### BEST MODE FOR CARRYING OUT THE INVENTION

A dope of the present invention and a dope preparation will be explained in following. The dope is a mixture obtained by stirring a polymer, an organic solvent and an additive.

The polymer to be used for the dope preparation is not restricted especially, and may be the already known polymer which is used for producing the polymer film by the solution casting method. Especially preferably, the polymer is cellulose acylate which is widely used for producing the polymer film for the optical use, for example, a protective film for a polarizing filter, an optical compensation film and the like. Cellulose acylate is obtained by acetylation of cellulose, and especially triacetyl cellulose (TAC). Thus the produced polymer film is excellent in transparency. Further, cyclic polyolefin is also preferably used as the polymer. The film produced from the cyclic polyolefin is excellent in transparency, the moisture stability and the heat stability of the optical properties.

In the present invention, the number and sort of the acyl groups in cellulose acylate may be only one or at least two. If there are at least two sorts of acyl groups, one of them is preferable the acetyl group. If the hydrogen atoms on the 2^{nd}, 3^{rd} and 6^{th} hydroxyl groups are substituted by the acetyl groups, the total degree of substitution is described as DSA, and if the hydrogen atoms on the 2^{nd}, 3^{rd} and 6^{th} hydroxyl groups are substituted by the acyl groups other than acetyl groups, the total degree of substitution is described as DSB. In this case, the value of DSA+DSB is preferably 2.22 to 2.90, especially 2.40 to 2.88.

Further, DSB is preferably at least 0.30, and especially at least 0.7. According to DSB, the percentage of the substitution on the 6^{th} position to that on the 2^{nd}, 3^{rd} and 6^{th} positions is at least 20%. However, the percentage is preferably at least 25%, particularly at least 30%, and especially at least 33%. Further, DSA+DSB of the 6^{th} position of the cellulose acylate is preferably at least 0.75, particularly at least 0.80, and especially at least 0.85. When these sorts of cellulose acylate are used, a solution (or dope) having preferable solubility can be produced. Especially, if the non-chlorine type organic solvent is used, the solubility becomes extremely high, the viscosity of the prepared dope is low, and the efficiency of the filtration with use of the filtration device becomes excellent.

Cellulose as a raw material of the cellulose acylate may be obtained from one of cotton linter or cotton pulp. If the cellulose is obtained from the cotton linter, the optical properties are easily controlled in the film production, and the dope contains little impurities. Thus the produced film has high transparency. Therefore the produced film is adequately used for the optical film.

In cellulose acylate, the acyl group having at least 2 carbon atoms may be aliphatic group or aryl group. Such cellulose acylate is, for example, alkylcarbonyl ester and alkenylcarbonyl ester of cellulose. Further, there are aromatic carbonyl ester, aromatic alkyl carbonyl ester, or the like, and these compounds may have substituents. As preferable examples of the compounds, there are propionyl group, butanoyl group, pentanoyl group, hexanoyl group, octanoyl group, decanoyl group, dodecanoyl group, tridecanoyl group, tetradecanyol group, hexadecanoyl group, octadecanoyl group, iso-butanoyl group, t-butanoyl group, cyclohexanecarbonyl group, oleoyl group, benzoyl group, naphthylcarbonyl group, cinamoyl group and the like. Among them, the particularly preferable groups are propionyl group, butanoyl group, dodecanoyl group, octadecanoyl group, t-butanoyl group, oleoyl group, benzoyl group, naphthylcarbonyl group, cinamoyl group and the like, and the especially preferable groups are propionyl group and butanoyl group.

In this embodiment, a casting film having a multilayer structure is formed by casting on a support a first dope for forming a contacting layer to the support, a second for forming a main layer and a third dope for forming an exposure layer exposed to the atmosphere. The viscosity of each first-third dopes is controlled in a predetermined range. The method of controlling the viscosity is not restricted especially. However, the polymers of different polymersization degrees are used in the preferable method of controlling the viscosities. The difference of the polymersization degree has influence of the viscosity of the dope. The dope of high viscosity is obtained from the polymer of high degree of polymerization, and the dope of low viscosity is obtained from the polymer of low degree of polymerization. Therefore, the drying time can be made shorter to increase the productivity than when a lot of solvent is used. Concretely, the polymer to be used for each dope is cellulose acylate of which polymerization degree is in the range of 250 to 450. Especially preferably, the polymer to be used for the first and second dopes is cellulose acylate of which polymerization degree is in the range of 300 to 450, and the polymer to be used for the third dope is cellulose acylate of which polymerization degree is in the range of 250 to 350.

In this case, the polymer is chosen such that the polymerization degree of the third dope for the exposure layer may be lower than the first dope for the contact layer and the second dope for the main layer. Thus the viscosity of the third dope is lower than the first and second dopes, and therefore the leveling effects become higher, such that the flatness of the film may be higher. As the method of adjusting the viscosity of the dope, for example, there is a method adjusting the amount of the organic solvent to be mixed with the polymer such that the solvent content in the dope may be adjusted. Note that the dope is a mixture in which the polymer is dissolved to or dispersed in the organic solvent.

In the present invention, the cyclic polyolefin means the polymer having a cyclic polyolefin structure. As such the polymer, there are (1) norbornene type polymer, (2) polymer of cyclic olefin having single ring, (3) polymer of cyclic conjugated diene, (4) vinyl alicyclic olefin, and hydride of the compound (1)-(4). The polymer to be preferably used in the present invention is addition (co-)polymer polyolefin which has at least one sort of repeating unit represented as chemical formula F1, and otherwise, addition (co-)polymer cyclic polyolefin which has at least one sort of repeating unit represented as chemical formula F2. Further, the ring-opened (co-)polymer is also preferably used that has at least one sort of repeating unit represented as chemical formula F3.

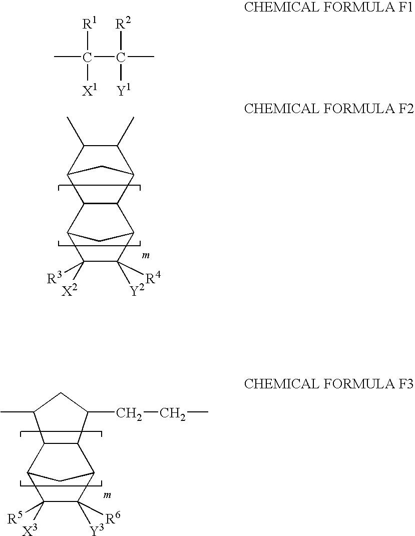

In chemical formulae F1-F3, m is an integral number 0 through 4. R¹-R⁶ are hydrogen atom or hydrocarbon group with a carbon number from 1 to 10, X¹-X³ and Y¹-Y³ are hydrogen atom, hydrocarbon group with a carbon number from 1 to 10, halogen atom, hydrocarbon group in which halogen is substituted for hydrogen, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ, —(CH₂)ₙW, and (—CO)₂O or (—CO)₂NR¹⁵ composed of a combination of X¹ and Y¹ or X² and Y² or X³ and Y³. Note that R¹¹-R¹⁵ are hydrogen atom or hydrocarbon group in which a number of the carbon atom is 1 to 20. Z is hydrocarbon group, hydrocarbon group in which halogen is substituted for hydrogen. W is SiR¹⁶_{P}D_{3-P}(R¹⁶ is a hydrocarbon group in which number of the carbon atom is 1 to 10; D is halogen atom, —OCOR¹⁶, or —OR¹⁶; P is an integral number 0 through 3), and n is an integral number 0 through 10.

Norbornene type addition (co-)polymer is disclosed in the Japanese Patent Laid-Open Publications No. 10-007732 and 2002-504184, the United States Patent Laid-Open Publication US2004229157A1, the International Publication WO2004/070463A1 and the like. The norbornene type addition polymer is also produced by the addition polymerization the norbornene type polycyclic unsaturated compounds. If necessary, the addition polymerization of the norbornene type polycyclic unsaturated compound and the diene compound may be made to produce the norbornene type addition polymer. The diene compound is conjugated diene, nonconjugated diene, linear diene and the like. The conjugated diene is, for example, ethylene, propylene, butane, butadiene, isoprene and the like. The nonconjugated diene is, for example, ethylidene norbornene and the like. The linear diene is, for example, acrylonitrile, acrylic acid, methacrylic acid, maleic acid anhydride, acrylic acid esters, methacrylic acid esters, maleimide, vinyl acetate, vinyl chloride and the like. The norbornene-type addition (co-)polymer to be used present invention is commercially available. Concretely, it is sold as APEL (product name) by Mitsui Chemicals Inc., and there are several grades among the APEL depending on the difference of the glass transition temperature (Tg). Concretely, there are, for example, APL8008T (Tg70° C.), APL6013T (Tg125° C.), APL6015T (Tg145° C.), and the like. further, the pellets of the norbornene addition (co-)polymer are sold as TOPAS8007, TOPAS6013, TOPAS6015 and the like by the Polyplastics Co. Ltd. Further, there is Appear 3000 produced by Ferrania S.p.A.

The norbornene type polymer hyderide to be used may be produced by the hydrization after the addition polymerization or the ring-opening metathesis polymerization of the polycyclic unsaturated compounds, as described in the Japanese Patent Laid-Open Publications No. 1-240517, 7-196736, 60-26024, 62-19801, 2003-1159767, 2004-309979 and the like. According to the norbornene type polymer to be used in the present invention, R⁵-R⁶ are preferably hydrogen atom or —CH₃, and further X³ and Y³ are preferably hydrogen atom, Cl, —COOCH₃. Other groups are selected adequately. As the norbornene polymer, the compound sold in the market may be used in the present invention. Concretely, the product name thereof is ARTON G and ARTON F (JSR Corporation), ZEONOR ZF14, ZEONOR ZF16, ZEONEX 250, ZEONEX 280 (Zeon Corporation), and these products can be used in the present invention.

According to the cyclic polyolefin polymer adequate for the present invention, the mass average molecular weight (Mw) measured by the Gel Permeation chromatography (GPC) is preferably in the range of 5,000 and 1,000,000 in terms of molecular weight of polystyrene, particularly 10,000 and 500,000, and especially 50,000 and 300,000. Further, the molecular distribution (Mw/Mn: Mn is a numeral average molecular weight measured by GPC) is preferably at most 10, particularly at most 5.0, and especially at most 3.0. The glass transition temperature (Tg: measured by DSC) is preferably 50° C. and 400° C., particularly 80° C. and 350° C., and 100° C. and 330° C.

Further, the organic solvents for preparing the dope are preferably compound which can dissolve cellulose acylate or the cyclic polyolefin. For example, there are aromatic hydrocarbons (for example, benzene, toluene and the like), hydrocarbon halides (for example, dichloromethane, chloroform, chlorobenzene and the like), alcohols (for example, methanol, ethanol, n-propanol, n-butanol, diethyleneglycol and the like), ketones (for example, acetone, methylethyl ketone and the like), esters (for example, methyl acetate, ethyl acetate, propyl acetate and the like), ethers (for example, tetrahydrofuran, methylcellosolve and the like) and the like.

The solvents are preferably hydrocarbon halides having 1 to 7 carbon atoms, and especially dichloromethane. Then in view of the dissolubility of cellulose acylate, the peelability of a casting film from a support, a mechanical strength of a film, optical properties of the film and the like, it is preferable that one or several sorts of alcohols having 1 to 5 carbon atoms is mixed with dichloromethane. Thereat the content of the alcohols to the entire solvent is preferably in the range of 2 wt. % to 25 wt. %, and particularly in the range of 5 wt. % to 20 wt. %. Concretely, there are methanol, ethanol, n-propanol, iso-propanol, n-butanol and the like. The preferable examples for the alcohols are methanol, ethanol, n-butanol, or a mixture thereof.

By the way, recently in order to reduce the effect to the environment to the minimum, the solvent composition when dichloromethane is not used is progressively considered. In order to achieve this object, ethers having 4 to 12 carbon atoms, ketones having 3 to 12 carbon atoms, esters having 3 to 12 esters are preferable, and a mixture thereof can be used. These ethers, ketones and esters may have the ring structure. Further, the compounds having at least two of functional groups (namely, —O—, —CO— and —COO—) in ethers, ketones and esters can be used for the solvent. Further, the solvent may have other functional groups, such as alcoholic hydroxyl groups, in the chemical structure.

In the above methods, the produced dope has the TAC concentration, preferably in the range of 5 wt. % to 40 wt. %, particularly preferably 15 wt. % to 30 wt. %, and especially 17 wt. % to 25 wt. %. Note that the dissolution method of the materials, the raw materials, the additives in the solution casting method for forming the TAC film is described in detail from [0517] to [0616] in Japanese Patent Laid-Open Publication No. 2005-104148, and the description of the publication can be applied to the present invention.

Note that the detailed explanation of cellulose acylate is made from [0140] to [0195] in Japanese Patent Laid-Open Publication No. 2005-104148, and the description of this publication can be applied to the present invention.

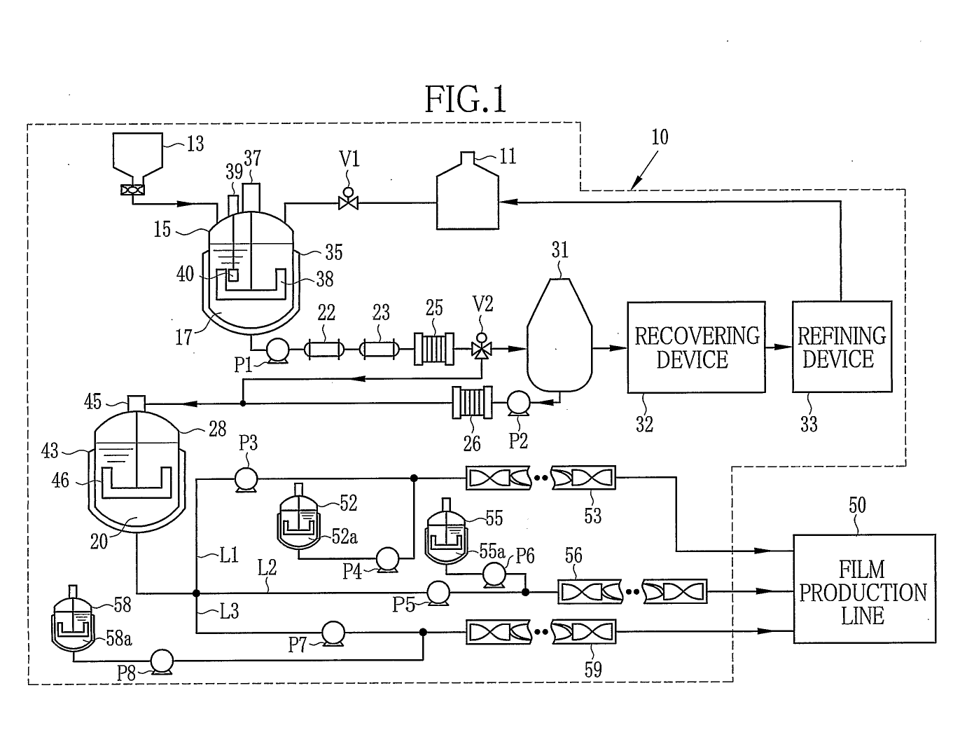

Then a method for preparing the casting dope will be explained in reference with FIG. 1. In the following explanations of preparing the dope, cellulose acylate is used as the polymer. It is to be noted that this figure illustrates only an example of the present invention, and therefore the present invention is not restricted in FIG. 1.

As shown in FIG. 1, a dope preparation line 10 includes a solvent tank 11 for storing a solvent therein, a hopper 13 for supplying the TAC, and a dissolution tank 15 for obtaining a mixture 17 which is obtained by mixing the solvent and cellulose acylate. Further, the dope preparation line 10 is provided with a heating device 22, a temperature controlling device 23, first and second filtration devices 25,26, a stock tank 28, and a flushing device 31. The heating device 22 heats the mixture 17 so as to dissolve the solid materials to the solvent more, and thus a primary dope 20 is obtained from the mixture 17. Thereafter the temperature controlling device 23 controls a temperature of the primary dope 20, and the primary dope 20 is stored in the stock tank 28. Further, in the flushing device 31, the concentrating of the primary dope 20 is made. Furthermore, the dope preparation line 10 includes a recovering device 32 for recovering the vapor of the solvent, and a refining device 33 for recycling the recovered solvent.

Note, the dissolution tank 15 has a jacket 35 covering over an outer surface, a first stirrer 38 rotating in accordance with the drive of a motor 37, and a second stirrer 40 rotating in accordance with the drive of a motor 39. The first stirrer 38 preferably has an anchor blade, and the second stirrer 40 is preferably an eccentric stirrer of a dissolver type. The jacket 35 forms a space on the outer surface of the dissolution tank 15, and a heat transfer medium is fed into the space. The inner temperature in the dissolution tank 15 is controlled with use of the heat transferring medium flowing within the jacket 35.

The mixture 17 is fed to the heating device 22 with use of the pump P1. The heating device 22 is preferably a pipe with a jacket for controlling the temperature. In heating the mixture 17, the dissolution of the swollen solid material in the mixture 17 proceeds. The temperature for dissolving in the heating device 22 is preferably in the range of 0° C. to 97° C. Further, the heating device 22 is preferably provided with a pressurizer for pressurizing the mixture 17, so as to make the solubility higher. Thus the solubility is effectively increased while the thermal energy doesn't damage the mixture 17. In the present invention, the heating doesn't mean the heating over the room temperature, but the increase of the temperature of the mixture 17 fed from the dissolution tank 15. For example, when the temperature of the fed mixture 17 is −7° C., the heating also means to increase the temperature to 0° C. and so on.

Instead of the heat-dissolution with use of the heating device 22, the mixture 17 as swelling solution may be cooled more in the range of −100° C. to −10° C. so as to perform the dissolution moreover, which is already known as the cool-dissolution method. In this embodiment, one of the heat-dissolution and cool-dissolution methods can be chosen in accordance with the properties of the materials, so as to control the solubility in the mixture 17.

The heated mixture 17 is fed to the temperature controlling device 23, so as to control the temperature nearly to the room temperature. Thus the primary dope 20 in which the polymer is dissolved to the solvent can be obtained. In this embodiment, the mixture 17 is fed out as the primary dope 20 from the temperature controlling device 23. The primary dope 20 is a solution or a dispersion of a polymer containing cellulose acylate. However, the dissolution of the polymer is preferably completed through the heating device 22.

The filtration devices 25, 26 are used for trapping undissolved or insoluble materials from the primary dope 20. The filter used in each of the first filtration devices 25, 26 preferably has an averaged porous diameter of at most 100 μm. However, if a porous diameter of the filter is too small, it takes long time for the filtration, and therefore the workability becomes lower. If the porous diameter of the filter is too large, it is hard to trap the foreign particles from the primary dope 20. Therefore, it is preferable to choose adequately the porous diameter of the filter in consideration of preparation time. The flow rate of the filtration in each first and second filtration devices 25, 26 is preferably at least 50 little/hr. Thus the dope preparation can proceed without making the preparation time longer.

The stock tank 28 is provided with a jacket 43 for covering an outer face thereof and a stirrer 46 rotated by a motor 45. A heat transfer medium whose temperature is controlled to a predetermined value is fed into a space between the jacket 43 and the outer face of the stock tank 28, similarly to the dissolution tank 15. Thus the inner temperature is adjusted. Further, while the primary dope 20 is stored in the stock tank 28, the stirrer 46 is continuously rotated by the motor 45, and the aggregation of the foreign particles occurs in the primary dope 20. Thus the concentration of the dope is kept uniform.

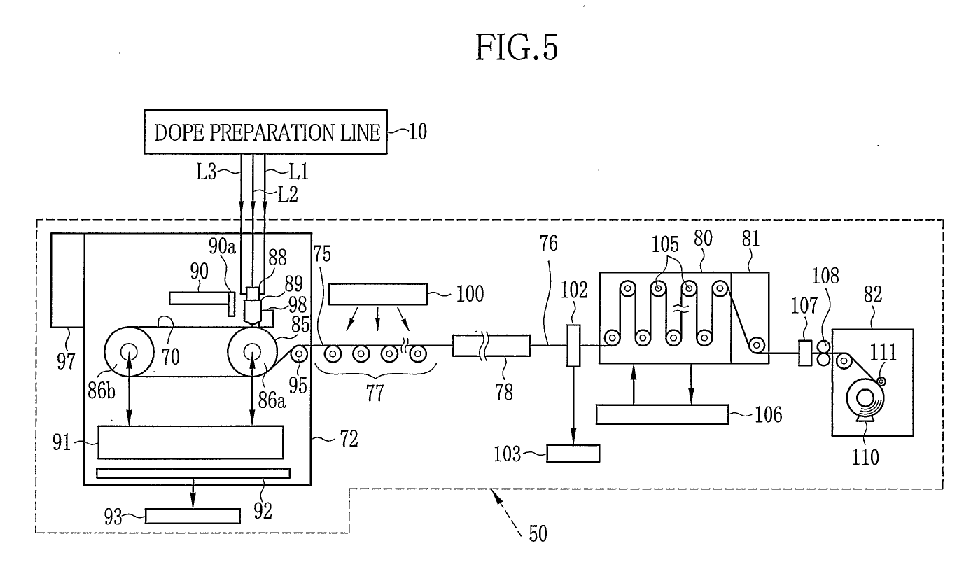

The stock tank 28 is connected to a second feed line L2 for preparing the second dope which forms the main layer, a first feed line L1 for preparing the first dope which forms the contact layer, and a third feed line L3 for preparing the third dope which forms the exposure layer. Note that another end of each first-third feed lines L1-L3 is connected to a casting die 89 (see, in FIG. 5) provided in a film production line 50. Thus the dope preparation line 10 is connected to the film production line 50 through the first-third feed line L1-L3.

In this embodiment, first-third tanks 52, 55, 58 respectively contains first, second, third liquids 52a, 55a, 58a which are independently prepared. Further, the first-third tanks 52, 55, 58 are respectively connected to the first, second and third lines L1-L3. Further, each first-third liquids 52a, 55a, 58a is a solution or a dispersion, in which a predetermined additive is added to a solvent. The additive is not restricted especially, and chosen in accordance with the characteristics of the layer to be formed. The preferable additive is the UV absorbing agent, the plasticizer, the retardation controller, the deterioration inhibitor, the peeling improver for easiness of the peeling from the casting belt as the support (for example, citric acid ester and the like), the matting agent (for example silicon dioxide and the like) and the like. Further, the solvent to be used for preparation the additive liquids 52a, 55a, 58a are not restricted especially. However, it is preferably the same as that for preparing the dope, such that the compatibility to the primary dope 20 may be higher.

The first-third liquids 52a, 55a, 58a may not be the same, and prepared independently in accordance with sort of the dope for forming the exposure layer, the main layer or the contact layer. For example, if the first and third dopes for respectively forming the exposure layer and the contact layer contain the matting agent, the peelability is increased. Further, in this case, when the product polymer film is wound to a film roll, the film surfaces contacting each other are prevented from adhesion. Furthermore, in this case, the matting agent doesn't precipitate in the main layer, and therefore the transparency becomes higher.

The particles are preferably derivative of silicon dioxide, which contains silicon dioxide and silicone resin having three dimensional net structure. Further, if the alkylation processing is made as the hydrophobization processing on the surface of the particles of the derivatives of the silicone dioxide, the dispersibility to the solvent is high. Therefore, the aggregation of the particles is reduced in the film production. Thus the surface defect is reduced and the transparency is excellent according to the produced film.

Note that the number of carbon atoms in each alkyl group to be provided on the surface of the particles in the alkylation is in the range of 1 to 20, preferably 1 to 12, and especially 1 to 8. If the particles with satisfaction with this conditions are used, the aggregation of the particles is reduced and the dispersibility becomes higher. If the number of the carbon atom in each alkyl group is in the range of 1 to 20, the particles can be obtained by treatment with use of octylsilane. Further, as an example of derivatives of silicon dioxide is aerosol R805 (trade name, Nippon Aerosil Co. Ltd.) which is sold in the market, which is preferably used in this embodiment.

A content of the particles to the solid content in the primary dope is preferably at most 0.2%. The content of the particles can be adjusted by determining the amount of adding the particles to the solvent used for the primary dope. Thus if the particles are added to the primary dope with control of the content, the generation of the foreign materials caused by the aggregation of the particles is reduced, and therefore the transparency of the film is excellent. Note that the averaged diameter of the particles is preferably at most 1.0 μm, particularly in the range of 0.3 μm to 1.0 μm, and especially 0.4 μm to 0.8 μm.

Note that the detailed explanation of the solvents and the additives (such as plasticizers, deterioration inhibitors, UV-absorptive agents, optical anisotropy controllers, dyes, matting agent, release agent, retardation controller and the like) is made from [0196] to [0516] in Japanese Patent Laid-Open Publication No. 2005-104148.

In this embodiment, a first static mixer 53 is provided for the first feed line L1, a second static mixer 56 is provided for the second feed line L2 and a third static mixer 59 is provided for the third feed line L3. The first-third static mixers 53, 56, 59 are disposed in downstream from points at which the first-third liquids 53a, 56a, 59a are respectively added. Therefore the primary dope 20 after the addition of each first-third liquid 53a, 56a, 59a is stirred. Thus the first-third dopes are prepared for respectively forming the exposure layer, the main layer and the contact layer.

Each device and member is connected by pipes made of stainless, since they are excellent in corrosion resistance and heat resistance. Further, pumps P1-P8 and valves V1, V2 are disposed at suitable positions. However, the positions and the numbers of the pumps and the valves are changed adequately, and are not restricted in this embodiment.

In following, a preparation method of the casting dope in the dope preparation line 10 will be explained.

At first the valve V1 is opened so as to feed the solvent from the solvent tank 11 to the dissolution tank 15. Cellulose acylate to be supplied to the hopper 13 is sent to the dissolution tank 15 with the measurement of quantity thereof. Thereafter in the dissolution tank 15, the first stirrer 38 and the second stirrer 40 are adequately rotated to mix the several sorts of the raw materials, and thus the mixture 17 is obtained. The inner temperature in the dissolution tank 15 is controlled with use of the heat transferring medium flowing within the jacket 15a. The preferable inner temperature is in the range of −10° C. to 55° C. The supply of the raw materials into the dissolution tank 15 is performed in the order of the solvent and cellulose acylate sequentially. However, the order is not restricted in this embodiment. For example, cellulose acylate and the solvent may be sequentially supplied.

Then the mixture 17 is fed to the heating device 22 with use of the pump P1, and heated therein to a predetermined temperature. Thus, the dissolution of the swollen solid material to the solvent proceeds, while the heating is performed at a predetermined temperature by the heating device 22. Thereafter, the mixture 17 is fed to the temperature controlling device 23, so as to control the temperature nearly to the room temperature. Thus the primary dope 20 is obtained. The primary dope 20 is filtrated with the first filtration device 25, so as to remove undissolved or insoluble materials. The filter used in the first filtration device 25 preferably has an averaged porous diameter of at most 100 μm. After the filtration, if the primary dope 20 has a predetermined concentration, the primary dope is fed to the stock tank 28 and stored until performance of the casting.

By the way, in the above method in which the mixture 17 is prepared and then the primary dope 20 is obtained from the mixture 17, if it is designated that the primary dope of higher concentration is produced, the time for production becomes longer. Consequently, the production cost sometimes becomes higher. Therefore, it is preferable that the primary dope of the lower concentration than the predetermined value is prepared at first and then the concentrating of the primary dope is made.

As such method, as shown in FIG. 1, the primary dope 20 has the lower concentration than the predetermined value, and after the filtration thereof through the first filtration device 25, the primary dope 20 is sent to the flushing device 31 through the valve V2. In the flushing device 31, the solvent of the primary dope is partially evaporated. The solvent vapor generated in the evaporation is condensed by a condenser (not shown) to a liquid state, and recovered by the recovering device 31. The recovered solvent is refined and recycled by the refining device 32 and reused. According to this method, the decrease of cost can be designated, since the production efficiency becomes higher and the solvent is reused.

The primary dope 20 after the concentrating as the above description is extracted from the flushing device 31 through the pump P2. Then the primary dope 20 is fed to the second filtration device 25, in which the undissolved and insoluble materials are removed. Note that the temperature of the primary dope 20 in the second filtration device 25 is preferably in the range of 0° C. to 200° C. Further, the primary dope 20 is fed to the stock tank 28 and stored. Further, in order to remove bubbles generated in the primary dope 20, it is preferable to perform the bubble removing treatment. As a method for removing the bubble, there are many methods which are already known, for example, an ultrasonic irradiation method and the like.

In the stock tank 28, the stirrer 46 is continuously rotated to stirrer the primary dope 20. Further, a heat transfer medium whose temperature is controlled is fed into the space between the jacket 43 and the stock tank 28, such that the inner temperature of the stock tank 28 may be controlled. Therefore, the temperature of the primary dope 20 stored in the stock tank 20 is also controlled to around a predetermined value.

The primary dope prepared by the above method is used for preparing the casting dope. In each first-third feed line L1-L3 for preparing the casting dope, the order and the method of adding a predetermined liquid is the same as those of preparing the primary dope 20. Therefore, in the following explanations, the method of preparing the second dope for forming the main layer in the second feed line L2 is explained, and the methods of preparing the first and third dopes are omitted.

First, a predetermined amount of the primary dope 20 is fed from the stock tank 28 by the pump P5. Then the second liquid 55a is fed out from the second tank 55 by the pump P6 and added to the primary dope 20 fed in the second feed line L2.

The second liquid 55a is a mixture of a solvent and a predetermined additive. The sort of the solvent is not restricted especially. However, it is the same as for the dope preparation, since the compatibility with the primary dope 20 is excellent. Further, if the additive is in the liquid state at the room temperature, the additive may be added as the second liquid 55a without the mixing of the solvent. Note that the additive will be made later in detail.

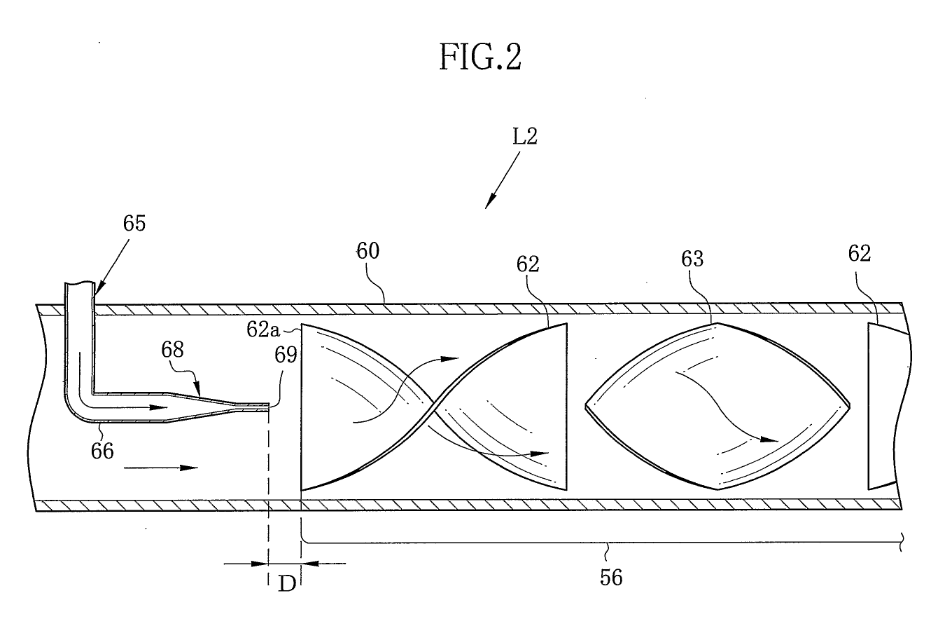

As shown in FIG. 2, the static mixer 56 is disposed in a pipe 60 through which the primary dope 20 flows, and has elements 62, 63 alternatively arranged in a flowing direction of the primary dope 20. The elements 62, 63 are formed by twisting rectangle plates at 180°, and the twisting direction of the element 62 is opposite to that of element 63. Further, according to the neighboring elements 62, 63, an upstream end of the element 63 forms a right angle with a downstream end of the element 62.

In an upstream side from the static mixer, there is a tube 65 for adding the second liquid 55a. The tube 65 includes a cylindrical main body 66 penetrating a wall of the pipe 60, and a nozzle attached to a downstream end of the tube 65. Further, the nozzle has a slit-shaped outlet 69.

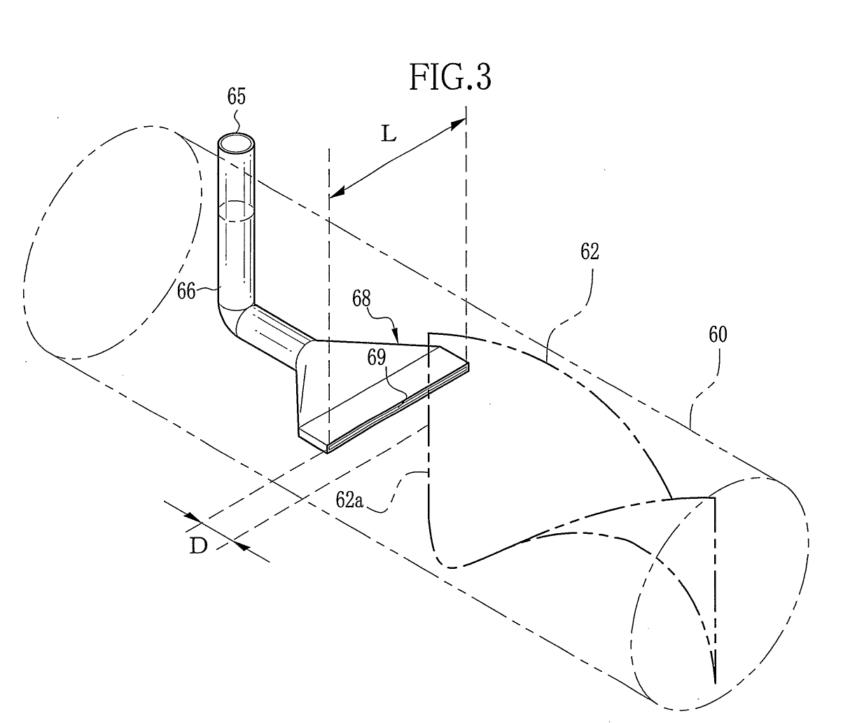

As shown in FIG. 3, the outlet 69 extends in a diameter direction of the pipe 60 in which the primary dope 20 flows. Further, a lengthwise direction of the nozzle 68 and the outlet 69 is perpendicular to an upstream end 62a of the element 62 which is nearest to the nozzle 68. When the second liquid 55a containing the volatile compounds is fed through the tube 65 and added through the outlet 69 of the nozzle 68 of the tube 65 to the primary dope 20 flowing in the pipe 60, the division of the volatile compound is firmly made from an upstream end of the static mixer, and the volatile compounds are stably and effectively passed into the pipe 60 without rotation. Therefore, the mixing and stirring of the primary dope 20 and the volatile compound is effectively made by rotating the element 62. Consequently, the number of elements of the static mixer can be made smaller, and thus the miniaturization of the process and the reduction of the cost can be made.

In order to add the second liquid 55a into the primary dope 20, a distance D between the outlet 69 and the upstream end 62a of the element 62 is preferably in the range of 1 mm to 250 mm, and particularly in the range of 2 mm to 250 mm. If the distance D is too small, the resistance of the primary dope 20 causes the stop of the nozzle 68, and if the distance D is too large, it is sometimes hard to infuse the volatile compound to a center of the static mixer 56.

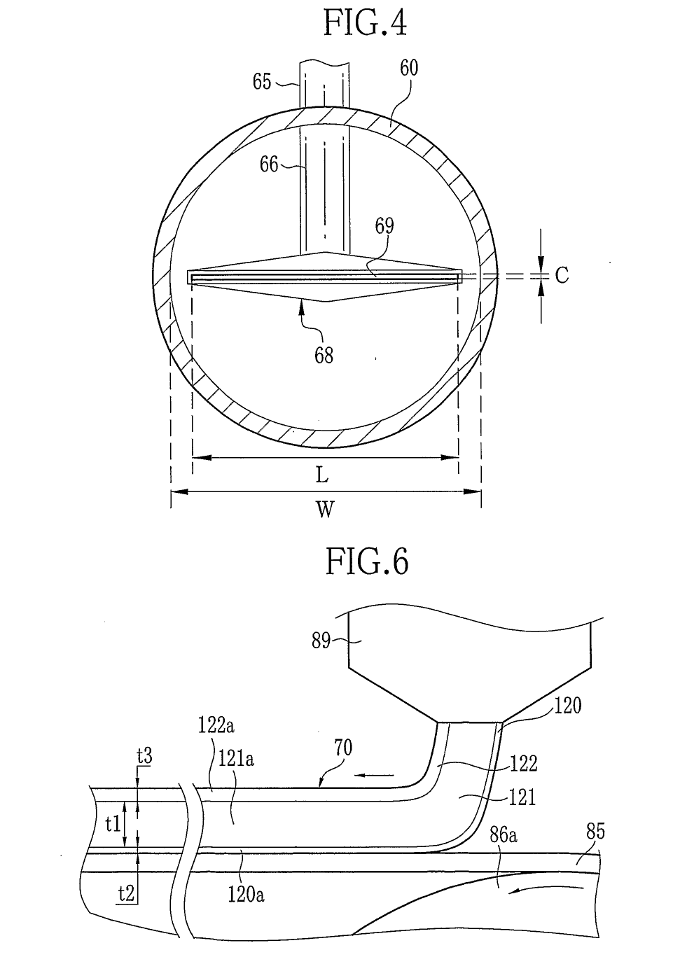

In order to add the second liquid 55a in the widthwise direction of the pipe 60 uniformly, as shown in FIG. 4, a length L (mm) of the slit-shaped outlet 69 is preferably in the range of 20% to 80% of an inner diameter W of the pipe 60, the percentage is calculate from the formula (L/W)×100. If the percentage is less than 20%, the length L is too short, and therefore the efficiency of stirring is too low. If the percentage is more than 80%, the length L is too large, and therefore part of the second liquid 55a enters into a space between the pipe 60 and the element 62. Further, a clearance C of the slit-shaped outlet 69 is preferably in the range of 0.1 mm to one tenth of the inner diameter W (mm) of the pipe 60, in order to add the second liquid 55a to the primary dope more certainly and effectively.

In order to disperse the second liquid 55a in the primary dope 20, a condition 1≦V1/V2≦5 is satisfied, wherein V1 is a current speed of the second liquid 55a flowing in the tube 65 and V2 is a current speed of the primary dope 20 flowing in the pipe 60. The current speeds V1, V2 are measured by the flow meter disposed in the pipe 60 and the tube 65. If the value V1/V2 is too small, the second liquid can not be continuously passed into the pipe 60. If the value V1/V2 is too large, the second liquid 55a sometimes flows through the second static mixer 53 very fast. Note that the flow rates through the pumps P3, P4 are measured by flow meters, and adjusted in accordance with the measured values.

Further, if a viscosity is N1 of the second liquid 55a and N2 of the primary dope 20, it is preferable that the viscosity N1 is in the range of 1×10⁻⁴ Pa·s to 1×10⁻¹ Pa·s, the viscosity N2 is in the range of 5 Pa·s to 5×10² Pa·s, and a ratio N2/N1 satisfies a formula, 1000≦N2/N1≦1,000,000. The viscosity may be measured by a viscosity meter which is already known. The above conditions of viscosities N1 and N2 are not restricted in the second liquid 55a, but applied to the first and third liquids 52a and 58a. The additive whose viscosity may satisfy the above conditions is prepared, and then added to the primary dope 20. Thus the viscosity of the primary dope can be adjusted after the addition of the additive.

Furthermore, the shear rate V3 of the primary dope 20 flowing in the pipe 60 is preferably in the range of 0.1 (sec⁻¹) to 30 (sec⁻¹). If the shear rate V3 is too small, the mixing is sometimes not made enough. If the shear rate V3 is too large, the pressure loss in the pipe 60 becomes too large. In this case, if the withstand pressure of the pipe 20 is force of 20×9.8 N, the pipe 20 is sometimes broken. On the basis of the same reason, a Reynolds number showing a situation of current of flux (namely the primary dope 20 in this embodiment) preferably satisfy a formula, Re≦200.

Consequently, the primary dope 20 after the addition of the second liquid 55a is stirred and mixed by the second static mixer 56 to be uniform, and therefore the second dope for forming the main layer becomes uniform. Further, the first dope for forming contact layer is similarly obtained in the first feed line L1 while the pumps P3, P4 are driven to add the first liquid 52a to the primary dope 20, and the third dope for forming the exposure layer is similarly obtained in the third feed line L3 while the pumps P7, P8 are driven to add the third liquid 58a to the primary dope 20.

In the above embodiment, the static mixer including the elements which are formed by twisting rectangle plates is used as an inline mixer. However, the inline mixer of the present invention is not restricted in this embodiment. For example, a sulzer mixer including an element which is formed by combining plural strip-like plates in a reticular pattern may be used as the inline mixer.

Further, the cyclic polyolefin may be used for the dope preparation. In this case, if the solvent to be used is selected adequately, the higher concentration dope can be obtained. Therefore, even if the concentration is not made, the cyclic polyolefin dope to be prepared has the higher concentration is excellent in the stability. Note that in the view point of the solubility, the lower concentration dope may be prepared at first as described above, such that the solid compounds may be completely dissolved. In this case, after the preparation, the concentration of the lower concentration dope is made such that the higher concentration dope may be obtained. The viscosity of the cyclic polyolefin dope before the casting is not restricted especially, so far as the dope can be used for the casting. However, the viscosity is usually preferably in the range of 3 Pa·s to 1000 Pa·s, particularly 5 Pa·s to 500 Pa·s, and 10 Pa·s to 200 Pa·s.

If some additive material is in solid state, the solid material may be fed into each feed line with use of a hopper. Further, if it is designated to add the several sorts of materials described above, the material to be added is previously dissolved to the solvent, and the obtained liquids may be added to the respective feed lines. Further, if some of the additive is in liquid state in the room temperature, the liquid material may be fed into the feed lines without using the solvent.

In followings, a method of producing a film with use of the casting dope will be explained in reference with FIG. 5.

As shown in FIG. 5, the film production line 50 includes a casting chamber 72, a transfer area 77, a tenter device 78, a drying chamber 80, a cooling chamber 81 and a winding chamber 82. In the casting chamber 72, the casting dope is cast onto the support to form a casting film 70. Further the casting film 70 is peeled as wet film 75 containing a solvent. Then the wet film 75 is transferred in the transfer area 77. Thereafter while the wet film 75 is conveyed in the tenter device 78 with both side edge portions of thereof clipped, the drying of the wet film 75 is made. The wet film 75 is fed out as a film 76 from the tenter device 78. In the drying chamber 80, the film 76 is dried, and in the cooling chamber 81, the film 76 is cooled down. Then the film 76 is wound up in the winding chamber 82.

In the casting chamber 72, there are back-up rollers 86a, 86b and a casting belt 85 supported by the back-up rollers 86a, 86b. Just above the back-up roller 86a, there are a feed block 88 to which the casting dope is supplied from the dope preparation line 10 and a casting die 89 having a slit-like die lip for discharging the casting dope. Further, there are an air blower 90 for feeding a drying air to dry the casting film 70 formed on the casting belt 85, and a circulating device 91 for feeding a heat transfer medium into the back-up rollers 86a, 86b, a condenser 92, a recovery device 93 and a roller 95. Outside of the casting chamber 72, there is a temperature controller for controlling an inner temperature of the casting chamber 72.

To the casting die 89 is attached a decompression chamber 98 for make the casting of the casting dope stably. Further, in an upstream side of the air blower 90 according to the running direction of the casting belt 85, an air shielding plate 99 is provided for preventing that the drying air fed out from the air blower causes the nonsmoothness of the surface of the casting film 72.

The back-up rollers 86a, 86b below the casting die 89 are rotated by a driving device (not shown), and thus the casting belt 85 runs endlessly in accordance with the rotation of the back-up rollers 86a, 86b. Then the casting volume is preferably in the range of 10 m/min to 200 m/min. In this embodiment, passages (not shown) of the heat transfer mediums are formed in the back-up rollers 86a, 86b, and the heat transfer mediums whose temperatures are controlled circularly pass through the passages by the medium circulating device 91. Thus the surface temperatures of the back-up rollers 86a, 86b are kept to the predetermined values. It is preferable that the surface temperature of the casting belt 85 is adjusted in the range of −20° C. to 40° C. by heat transmission from the back-up rollers 86a, 86b.

The width of the casting belt 85 is not restricted especially. However, it is preferably in the range of 1.1 to 2.0 times larger than a casting width of the discharged casting dope. Further, the casting belt 85 is from 20 m to 200 m in length and 0.5 mm to 2.5 mm in thickness, and the thickness unevenness is at most 0.5%. The surface is preferably polished so as to have a surface roughness at most 0.05 μm. Thus the casting film 70 can be formed without forming scratches on the film surface, and therefore the casting film 70 and the produced film 76 are excellent in planarity. In consideration of the peelability of the casting film 70, endurance and heat resistance, the casting belt 85 is preferably made of stainless, and especially of SUS 316 so as to have enough resistance of corrosion and strength.

The inner temperature of the casting chamber 72 is adjusted by the temperature controller 97 so as to be an adequate temperature for drying the casting film 70. In progress of the drying of the casting film 70, the solvent vapor evaporated from the casting film 70 exists in the inside of the casting film 72. However, the solvent vapor is liquidized by the condenser 72 and thereafter recovered by the recovering device 93. The recovered solvent is refined and recycled by a recycling device (not shown) such that the impurities may be removed. Thus the solvent is recycled for the dope preparation, which decrease the cost for materials and the production cost.

The casting die 89 is preferably a coat hanger type die. A width of the casting die 89 is not restricted especially. However, the width is preferably in the range of 1.05 to 1.5 times as large as the casting width of the casting dope, and in the range of 1.01 to 1.3 times as large as the produced film 76. Further, in order to make the casting of the casting dope smoothly, the surface of the casting die 89 is preferably polished so as to have a surface roughness at most 0.05 μm. Further, the material to be used for the casting die 89 had enough endurance and corrosion resistance, such that the pitting (or pitting corrosion) might not occur on the gas-liquid interface even if this material were dipped in a mixture liquid of dichloromethane, methanol and water for three months. The casting die 89 is preferably made of stainless, and especially of SUS 316 for providing the enough corrosion resistance. However, the materials for the casting die 89 are not restricted especially so far as the corrosion resistance is almost the same as that of SUS316 in the compulsory corrosion experiment in an electrolyte solution. Further if the casting die 89 is made of the material whose coefficient of thermal expansion is at most 2×10⁻⁵ (° C.⁻¹), the necessary for considering the heat damage is reduced.

The casting die 89 is preferably produced by grinding the materials at least one month after the molding. Thus the casting dope flows smoothly in the casting die 89, and therefore the casting film 70 to be formed is excellent in the smoothness without occurrence of streaks. However, in order to increase the above effects, it is preferable that the finish accuracy of the contact surface of each casting die to the casting dope is at most 1 μm in surface roughness, the straightness is at most 1 μm/m in any direction, and the slit clearance is adjustable in the rage of 0.5 mm to 3.5 mm. According to an edge of the contact portion of a lip end of the casting die 89, R is at most 50 μm in all of a width. Further, the shearing rate in the casting die 89 controlled in the range of one to 5000 per second.

It is preferable to attach a temperature controller (not shown) to the casting die 90, such that the temperature may be kept to the predetermined one during the film production. Further, the casting die 90 is preferably a coat hanger type die. The thickness of the casting film is often controlled by adjusting a feed rate of the feed pump from the casting die 90. Further, in order to adjust a thickness profile in a widthwise direction of the casting film, the casting die 90 is preferably provided with an automatic thickness adjusting device. For example, it is preferable that thickness adjusting bolts (heat bolts) for controlling a lip clearance are disposed as the automatic thickness adjusting instrument at a predetermined interval in a widthwise direction of the casting die 90. Note that the film thickness is defined in consideration with a change of the thickness and the smoothness in the widthwise direction. Further, according to the heat bolts, it is preferable that the profile is set on the basis of a predetermined program, depending on feed rate of a pump (not shown). Further, the feed back control of the adjustment value of the heat bolts may be made by the adjusting program on the base of the profile of a thickness gauge (not shown), such as infrared ray thickness gauge and the like. Preferably, the thickness difference between any two points in the widthwise direction except the side edge portions in the casing film is to at most 1 μm, and the thickness difference in the widthwise direction is at most 3 μm. Further, the accuracy to the designated object value of the thickness is preferably in ±1.5 μm.

Preferably, a hardened layer is preferably formed on a top of the lip end. A method of forming the hardened layer is not restricted. But it is, for example, ceramics hard coating, hard chrome plating, neutralization processing, and the like. If ceramics is used as the hardened layer, it is preferable that the used ceramics is grindable but not friable, with a lower porosity. Further preferably, the ceramics have low wetting property. Concretely, there are tungsten carbide (WC), Al₂O₃, TiN, Cr₂O₃, and the like. Especially preferable ceramics is tungsten carbide. Tungsten carbide coating can be made by an spraying method.

Further, in order to prevent the partial dry-solidifying of a dope on a slit end of the casting die 90, it is preferable to provide a solvent supplying device (not shown) at the slit end, on which a gas-liquid interfaces are formed between both edges of the slit and both bead edges and the outer gas. Preferably, these gas-liquid interfaces are supplied with the solvent which can dissolve the dope, (for example a mixture solvent of dichloromethane 86.5 pts. wt., methanol 13 pts. wt., n-butanol 0.5 pts. wt.). The solvent is preferably supplied to each edges of the bead from 0.1 mL/min to 1.0 mL/min. Thus the solidifications at both bead edges and the mixing of the solid into the casting film are prevented. Note that the pump for supplying the solvent has a pulse rate at most 5%.

Further, it is necessary during the casting of the casting dope to stabilize the formation of a bead of the discharged casting dope between the casting die 89 and the casting belt 85, in order to produce the film 76 excellent in optical properties. Therefore, it is preferable to provide the decompression chamber 68 for controlling the pressure in the upstream side from the bead. When the pressure in the upstream side from the bead is adjusted by the decompression, it is prevented that the wave-like unevenness is formed on the surface of the bead in effect of the wind in the atmosphere. The pressure in the upstream side from the bead is not restricted especially. However, in order to produce the casting film 70 excellent in the smoothness, the pressure is preferably in the range of 10 Pa to 2000 Pa lower than the atmospheric pressure.

In the transfer area 77, there are a plurality of rollers and a drying device 100 for feeding out to the wet film 75 a drying air whose temperature is adjusted so as to make the drying faster. Further, the tenter device 78 includes a chain (not shown) running on a rail (not shown), clips (not shown) attached on the chain, and a dryer (not shown). In the downstream from the tenter device 78, an edge slitting device 102 for slitting both side edge portions of the film 76 is disposed.

In the drying chamber 80, there are a plurality of rollers and an adsorbing device 106. Further, the drying chamber 80 is provided with a temperature controlling device (not shown) for controlling the inner temperature. The cooling chamber 81 cools the film 76 to a room temperature. Thereafter, a compulsory neutralization device (or a neutralization bar) 107 eliminates the charged electrostatic potential of the film 76. Further, in the winding chamber, the winding roller 110 and the press roller 111 are provided.

In following, the order of producing the film 76 in the film production line 50 will be explained.

First, the second dope for forming the main layer, the first dope for forming the contact layer, and the third dope for forming the exposure layer are respectively fed through the first-third feed line L1-L3 to the feed block 88, while the feed amount of the first-third dopes is controlled adequately. In the feed block 88, there are respective passages for the first-third dopes, and the first-third dopes are joined into the casting dope. Thereafter, the casting dope is fed to the casting die 89.

In the casting chamber 72, the air blower 90 has an outlet (not shown). The outlet is directed in the running direction of the casting belt 85 (or the conveying direction of the casting film). The drying air whose temperature is controlled is fed out from the outlet toward the casting film 70 on the casting belt 85 such that the feeding direction of the drying air may be almost in parallel to the conveying direction. Thus it is prevented to form the unevenness on the film surface of the casting film 70. Further, in the casting chamber 72, the solvent vapor evaporated from the casting film 70 is liquidized by the condenser 92, and thereafter recovered by the recovering device 93. The recovered solvent is refined and recycled by the refining device (not shown) and reused as the solvent for the dope preparation.

When the casting film 70 has self-supporting property, it is peeled as the wet film 75 from the belt 72 with support of the roller 95. The content of remaining solvent in the wet film 75 just after the peeling is preferably in the range of 10 wt. % to 200 wt. %. Note that the content of the remaining solvent is that on dry basis and measured with use of the samples of the casting film 70 and the produced film which is completely dried. If the sample weight of the casting film 70 was x and the sample weight after the drying was y, the solvent content on the dry basis (%) was calculated in the formula, {(x−y)/y}×100.

Thereafter, the wet film 75 is transported through the transfer area 77 provided with many rollers. In the transfer area 77, while the wet film 75 is transferred with support of the rollers, the drying air is fed out from the air blower 100 such that the drying of the wet film 75 may be made. The temperature of the drying air from the air blower 100 is preferably controlled in the range of 20° C. to 250° C. The temperature of the drying air may be determined optionally in consideration of the sorts of polymer, additives and the like used for the casting dope, the production speed and the like.

In the transfer area 77, the rotation speed in the downstream side of the wet film 75, namely near the exit of the transfer area 77, is preferably faster than that in the upstream side. Thus the adequate tension is applied to the wet film 75 to reduce the wrinkles and the creases. Further, the orientation is easily adjusted by applying the tension to the wet film 75 in which the content of remaining is high. Thus the retardation of the produced film 76 is controlled adequately.

Thereafter the wet film 75 is transported into the tenter device 78. In the tenter device 78, both side edge portions are clipped by clips (not shown), and thereafter the drying air is fed out from an air blower (not shown) to the transported wet film 75. Therefore, the drying of the wet film 75 proceeds, and is fed out as the film 76 from the tenter device 78. further, in the tenter device 78, the distance of the paired clips arranged in the widthwise direction of the wet film 78 is made larger, the wet film 78 is stretched in the widthwise direction. Thus the orientation of the molecular in the wet film 75 is adjusted, and therefore the retardation value of the film 85 obtained can be controlled to the predetermined value. Further, the tension to be applied in the widthwise direction is adjusted, such that the stretch of the wet film 57 may be made. Thus the thickness of the wet film 57 can be adjusted.

The inside of the tenter device 78 is preferably partitioned into plural partitions whose temperatures are independently controlled. Thus in the transfer of the wet film 75, the wet film 75 is gradually dried at the different temperatures, which reduces the sudden evaporation of the solvent and therefore the deformation of the film. Consequently the produced film is excellent in the smoothness. Note that the tenter device 78 of this embodiment is the clipping type having a plurality of clips as clipping members. However, instead of the clips, pins may be provided in the tenter device 78. In this case, the pins are stroked into the both side edge portions of the wet film 75, and thereafter the stretching of the wet film 75 in the widthwise direction is made.

The stretch and the relaxation of the wet film 75 in the lengthwise direction is made in the transfer area 77, and that in the widthwise direction is made in the tenter device 78. The method of the stretch and the relaxation in the transfer area 77 may be performed with control of the rotation speed of the roller as described below. In these cases, the stretch ratio as percentage of difference of the film length or the film width between after and before the stretch is in the range of 0.5% to 300%. Note that while the tension is applied to the wet film 75 in the transfer area 77 or the tenter device 78, the drying temperature is preferably kept almost constant. Thus it is prevented that the temperature difference causes the difference of the stretch ratio.

The wet film 75 is fed out as the film 76 from the tenter device 100 toward an edge slitting device 102 for slitting off both side edge portions which are damaged in the tenter device 78. The slit side edge portions are sent to a crusher 103 by a cutter blower (not shown), and crushed to tips by the crusher 103. The tips are reused for preparing the dope, which is effective in view of the decrease of the production cost. Thus the both side edge portions which are damaged by the clipping in the tenter device 78 can be removed, and therefore the produced film 76 is excellent in smoothness. Note that the slitting process of both side edge portions may be omitted. However, it is preferable to perform the slitting between the casting process and the winding process.

The film 76 whose side edge portions are slit off is sent to the drying chamber 80 and dried furthermore therein. In the drying chamber 80, the film 76 is transported with lapping on the rollers 104. The inner temperature of the drying chamber 80 is not restricted especially. However, it is preferable in the range of 60° C. to 145° C. The surface temperature of the film 76 is measured by a thermometer disposed above the transport path of the film 76. Thus the heat damage of the polymer in the film 76 is prevented and the evaporation of the solvent is effectively made. Thus the drying is made enough. Further, in this embodiment, the solvent vapor evaporated from the film 76 by the drying chamber 80 is adsorbed and recovered by the adsorbing device 106. In the adsorbing device, the solvent vapor is removed from the air, which is reused as the drying air in the drying chamber 80. Thus the energy cost and therefore the production cost are decreased.

If the temperature of the film 76 increases suddenly, the form of the film 76 changes. Therefore, a pre-drying chamber (not shown) may be provided for the pre-drying of the film 76 between the edge slitting device 102 and the drying chamber 80. Thus the sudden increase of the temperature of the film 76 is prevented.

The film 76 is transported into the cooling chamber 80, and cooled therein to around the room temperature. A humidity control chamber (not shown) may be provided for conditioning the humidity between the drying device 70 and the cooling chamber 80. Thus the film 76 is set after the conditioning the humidity thereof into the cooling chamber 81. Therefore the wrinkles on the film surface are reduced.

Thereafter, a compulsory neutralization device (or a neutralization bar) 107 eliminates the charged electrostatic potential of the film 76 to the predetermined value (for example, in the range of −3 kV to +3 kV). The position of the neutralization process is not restricted in this embodiment. After the neutralization, the embossing of both side portions of the film 76 is made by the embossing rollers to provide the knurling. If the emboss is provided, the smoothness of the film 76 becomes larger.

In the last process, the film 76 is wound by a winding shaft 110 in the winding chamber 82. At this moment, a tension is applied at the predetermined value to a press roller 111. In order to wind the film 76 without the occurrence of the wrinkle and the crease, it is preferable that the tension is gradually changed from the start to the end of the winding. In the present invention, the length of the polymer film 76 is preferably at least 100 m. The width of the film is preferably in the range of 1400 mm to 2500 mm. Further, even if the width is more than 2500 mm, the present invention is effective.

The thickness of the produced film 76 is preferably in the range of 20 μm to 100 μm, particularly in the range of 20 μm to 80 μm, and especially in the range of 30 μm to 70 μm. However, the present invention is not restricted in the above values of the thickness.

In FIG. 6, the numerals of the first-third dopes constructing the casting dope are respectively 120, 121 and 122. The co-casting of the casting dope onto the casting belt 85 is made so as to form the casting film 70. Among the first-third dopes 120-122, at least tow ones have the different viscosities. In this embodiment, the casting film 70 has a three layer structure, the numerals of the exposure, base and contact layers are respectively 120a, 121a, and 122a. In the casting film 70, if the thickness is described as t1 (μm) of the contact layer 120a, t2 (μm) of the main layer 121a and t3 (μm) of the exposure layer 122a, it is preferably to satisfy a formula, t1≦t3≦t2. Thus the thickness of the main layer 121a is the largest, and that of the exposure layer 120a is almost the same as the main layer 121a. In this case, the bead of the casting dope is stably formed, and the leveling effect of the exposure layer 120a becomes high. Thus the occurrence of the unevenness on the exposure layer is prevented. Furthermore, the thickness of the contact layer 122a is almost the same as the exposure layer 120a, the drying can be made enough, and the part of the casting film doesn't remain on the surface of the casting belt 85. Under the condition t2<t3, the drying time becomes longer and therefore the productivity becomes lower. Further, under the condition t3<t1, the thickness of the support layer 122a may be determined so far as the drying can be made enough. However, in this case, if the support layer formed for making the peelability higher is too thin, the leveling effect becomes decrease.

Further, the percentage of the thickness t3 of the exposure layer to the total thickness t1+t2+t3 of the casting film is preferably in the range of 3% to 40%, and especially 5% to 30%. The thickness of each exposure, main and contact layer 120a-122a can be controlled by adjusting the flow rate of the dope and the casting width.

The viscosity is described as η1 (Pa·s) of the first dope 120, η2 (Pa·s) of the second dope 121, and η3 (Pa·s) of the third dope 122. Preferably the viscosities satisfy a formula, η3≦η1≦η2, and η3 satisfies a formula, 5 Pa·s≦η3≦30 Pa·s, and preferably 10 Pa·s≦η3≦20 Pa·s. Thus the leveling effects of the exposure layer become adequate and the casting bead is stably formed. However, in the present invention, the viscosities η1, η2, η3 are independently adjusted, and the values thereof are not restricted especially so far as the above conditions are satisfied. For example, the condition may be η3≦η1 and η1=η2, or η3=η1 and η1≦η2. Further, η3 satisfies a condition, preferably 5 Pa·s≦η3≦30 Pa·s, and especially 10 Pa·s≦η3≦20 Pa·s. Thus the leveling effects of the exposure layer 120a become larger.

According to the third dope for the exposure layer, if the weight of the solid material is described as A, and the weight of the solvent is described as B, the percentage X of the solid material in the third dope is represented as [(A−B)/A]×100. Thus the percentage X is preferably in the range of 16% to 21%, and especially 16% to 19%, while (A−B) is the solid content, namely the quantity of polymer and the additive contained in the dope. The solid material is the additive and the polymer contained in the dope. The dope satisfying the above condition of the content of the solid material has the low viscosity. Therefore the pressure loss occurring at the discharge of the dope from the casting die becomes lower, such that the casting bead may be formed stably. Further, a shark skin, namely a slight thickness unevenness occurring in the bead at the discharging, is reduced. Thus the produced film is excellent in the smoothness. Further, the casting film has high liquidity. Therefore, even if the unevenness such as wave-like stripes occurs by the disorder of the atmosphere and the conditions, the surface becomes smooth in effect of the surface tension. This phenomena is described as the leveling in above. However, if the content of the solid material is less than 16 wt. %, the viscosity is too low, and the drying air applied to the casting film disturbs the smoothing of the film surface. Thus the film surface does not become smooth, and the smoothness becomes lower. If the content is more than 21%, the viscosity is too high, and the shark skin occurs more at the discharging. Therefore, the leveling effect becomes lower, and the smoothness becomes lower.

The smoothness of the produced film depends on third dope for the exposure layer mainly. In the present invention, the viscosity of the third dope is the lowest, and the viscosity and the thickness of the first dope is the largest. Thus the dope of the high viscosity is cast at most. Therefore the bead formation becomes stable and the drying of the casting film on the support is made faster. Further, the drying air has the largest influence on the smoothness of the exposure layer. In the present invention, since the exposure layer is formed of the third dope of the low viscosity, the leveling effect becomes larger, and thus it is reduced that the smoothness of the casting layer becomes lower. Further, since the smoothness becomes larger, the surface conditions of the produced film become adequate. In this case, the stretch unevenness is also prevented, while it occurs by stretching the wet film in the tenter device during the film production.

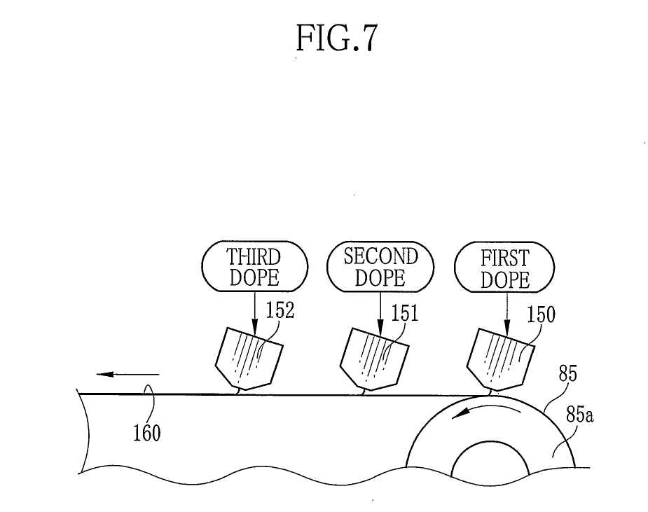

In the solution casting method of the present invention, there are casting methods for casting plural dopes, for example, a co-casting method and a sequential casting method. In this embodiment, the co-casting method is performed. In the sequential casting method, as shown in FIG. 7, plural dopes are cast from casting dies 150-152 sequentially. The casting die 150 is disposed in the most upstream position from the other casting dies 151, 152, and discharges the first dope for forming the contact layer. Then the casting die 151 is disposed downstream from and next to the casting die 150, and discharges the second dope for forming the main layer. The casting die 152 is disposed the most downstream position, and discharges the third dope for forming the exposure layer. Thus the casting film 160 has a three layer structure. Further, in the present invention, the co-casting method and the sequential casting method may be combined. Further, the feed block may be attached to at least one of the casting dies 150-152, and otherwise the casting die may be a multi-manifold type.

The structure of the casting die, the casting chamber and the support, the co-casting, the peeling, the stretch, the drying conditions in each process, the handling, the curling, the winding method after the correction of the smoothness and the recovering of the solvent and the film are described from [0617] to [0889] in the Japanese Patent Laid-Open Publications No. 2005-104148.

[Properties & Measuring Method]

(Degree of Curl & Thickness)

Japanese Patent Laid-Open Publication No. 2005-104148 describes from [1073] to [1087] about the properties of the wound cellulose acylate film and the measuring method thereof. The properties and the measuring methods can be applied to the present invention.

[Surface Treatment]

The cellulose acylate film is preferably used in several ways after the surface treatment of at least one surface. The preferable surface treatments are vacuum glow discharge, plasma discharge under the atmospheric pressure, UV-light irradiation, corona discharge, flame treatment, acid treatment and alkali treatment. Further it is preferable to make one of these sorts of the surface treatments.

[Functional Layer]

(Antistatic, Hardened, Antireflection, Easily Adhesive & Antiglare Layers)

The cellulose acylate film may be provided with an undercoating layer on at least one of the surfaces, and used in the several ways.

It is preferable to use the cellulose acylate film as a base film to which at least one of functional layers may be provided. The preferable functional layers are an antistatic layer, a cured resin layer, an antireflection layer, an easily adhesive layer, an antiglare layer and an optical compensation layer.

These functional layers preferably contain at least one sort of the surfactants in the range of 0.1 mg/m² to 1000 mg/m². Further, the functional layers preferably contain at least one sort of the lubricants in the range of 0.1 mg/m² to 1000 mg/m². Furthermore, the functional layers preferably contain at least one sort of the matting agent in the range of 0.1 mg/m² to 1000 mg/m². Furthermore, the functional layers preferably contain at least one sort of the antistatic agent in the range of 1 mg/m² to 1000 mg/m². Conditions and Methods for forming the functional layer are described in detail from [0890] to [1087] of Japanese Patent Laid-Open Publication No. 2005-104148, which can be applied to the present invention. Thus the produced film can have several functions and properties.

(Variety of Use)

The produced cellulose acylate film can be effectively used as a protection film for a polarizing filter, and an optical compensation film. In the polarizing filter, the cellulose acylate film is adhered to a polarizer. Usually, two polarizing filters are adhered to a liquid crystal layer such that the liquid crystal display may be produced. Note that the arrangement of the liquid crystal layer and the polarizing filters are not restricted in it, and several arrangements already known are possible. Japanese Patent Laid-Open Publication No. 2005-104148 discloses the liquid crystal displays of TN type, STN type, VA type, OCB type, reflective type, and other types in detail. Further, in the description of this application, a cellulose acylate film is provided with an optically anisotropic layer, and another cellulose acylate film is provided with antireflective and antiglare functions. Further, the publication describes about the optically biaxial cellulose acylate film provided with adequate optical properties. This cellulose acylate film may be used with the protective film for the polarizing filter. These descriptions of the publication No. 2005-104148 continues from [1088] to [1265] which can be applied to the present invention.

In followings, performed examples of the present invention will be explained. However, the present invention is not restricted in the examples.

The following compounds are mixed such that the each dope for the contact, base and exposure layers may be produced by the dope preparation line 10 shown in FIG. 1. In this example, not only the solvent tank 11 but also a methanol tank (not shown) for storing a methanol is prepared. It is to be noted in this example that the solvent components stored in the solvent tank 11 is dimethyl methane as a first solvent component and the alcohol in the alcohol tank is uses as a second solvent component.

### EXAMPLE 1

The following compounds are mixed such that a TAC dope A may be prepared as the third dope 122 for the exposure layer. Note that the mixture solvent in which the dichloromethane and the methanol are mixed in the following mixing ratio was used. Further, the retardation controller and the particles are mixed with the mixture solvent, such that the third liquid 58a may be obtained.

<Production of TAC Dope A to be used
as Third Dope for Exposure Layer>

| | | |
|---|---|---|
| Cellulose Triacetate (TAC) | 100 | pts. wt. |
| (Powder: degree of acetylation, 60.2%; | | |
| viscosity-average degree of polymerization, | | |
| 305; viscosity of 6 mass % | | |
| dichloromethane solution, 250 mPa · s) | | |
| TPP | 7.6 | pts. wt. |
| BDP | 3.8 | pts. wt. |
| Dichloromethane (first solvent component) | 474 | pts. wt. |
| Methanol (second solvent component) | 65 | pts. wt. |
| Retardation Controller of chemical formula F4 | 7 | pts. wt. |
| Particles (silicon dioxide, particle | 0.05 | pts. wt. |
| diameter 15 nm; Mohs Hardness, about 7) | | |

Note that the retardation controller and the particles are used as the third liquid 58a.

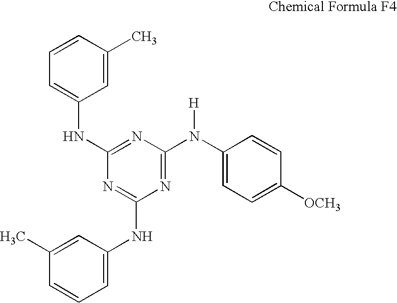

First, an adequate amount of the dichloromethane was fed from the solvent tank 11 to the dissolution tank 15, and thereafter an adequate amount of the methanol was fed from the methanol tank to the dissolution tank 15. Then the cellulose triacetate was fed from the hopper 13 to the dissolution tank 15. Thereafter, the stirring of the cellulose triacetate, the dichloromethane and the methanol was made in the dissolution tank 15, such that the mixture 17 might be obtained. Then the mixture 17 was fed to the heating device 22 in which the cellulose triacetate was dissolved to the solvent moreover, and cooled about to the room temperature by the temperature controller 23, such that the primary before the concentration dope might be obtained. The primary dope was fed to the flush device 31, in which the evaporation of the solvent was performed. Thus the primary dope 20 of the predetermined concentration was obtained.

The concentrated primary dope 20 was extracted from the flush tank 31 by the pump P2, and the defoaming was performed by irradiating very weak ultrasonic waves. Thus the filtration was made by the second filtration device 26 such that the impurity might be trapped. Then the primary dope 20 was fed to the stock tank 28.

Then part of the primary dope 20 was fed into the third feed line L3. Then the pump P8 was driven to feed the third liquid 58a from the second tank 58 to the second feed line L2. The primary dope 20 and the third liquid 58a are mixed and stirred by the static mixer 59. Thus the third dope for forming the exposure layer is prepared. The viscosity η3 of the third dope 120 was 15 Pa·s. Further, in the third dope for the exposure layer, the percentage of the solvent to the weight of the dope, namely the content X of the solid compound the third dope was 18%. The content X is represented as [(A−B)/A]×100), if the weight of the dope is A and the weight of the organic solvent is B.

The following compounds are mixed such that the first dope for the contact layer and the second dope for the main layer may be prepared. According to the first and second dopes, the percentage X was 23%. The preparation of the first and second dopes are made such that the concentration thereof may be higher than that of the third dope.

<Production of TAC Dope B to be used as First Dope
for Contact Layer &Second Dope for Main Layer>

| | | |
|---|---|---|
| Cellulose Triacetate (TAC) | 100 | pts. wt. |
| (Powder: degree of substitution, 2.81 (degree of | | |
| acetylation, 60.2%); viscosity-average degree of | | |
| polymerization, 305; viscosity of 6 mass % | | |
| dichloromethane solution, 400 mPa · s) | | |
| TPP | 7.6 | pts. wt. |
| BDP | 3.8 | pts. wt. |
| Dichloromethane (first solvent component) | 371 | pts. wt. |
| Methanol (second solvent component) | 51 | pts. wt. |
| Retardation Controller of chemical formula F4 | 7 | pts. wt. |
| Particles | 0.05 | pts. wt. |
| (silicon dioxide, particle diameter, 15 nm; | | |
| Mohs Hardness, about 7) | | |

Note that the retardation controller and the particles are contained in the first and third liquid 52a, 58a.

A TAC dope B was prepared in the above method and used as the first & second dopes for the contact and main layers. Then the first-third dopes 120-122 produced from the TAC were fed in the film production line 50. First, the co-casting of the first-third dopes 120-122 from the casting die 89 onto the casting belt 85 was made so as to form the casting film 70 having a three layer structure of the main layer 121a, the contact layer 120a and the exposure layer 122a. At the casting, the casting volume of each dope is adjusted, such that the thickness t1 of the contact layer 120a, the thickness t2 of the main layer 121a, the thickness t3 of the exposure layer 122a may satisfy the formula, t1≦t3≦t2.

Then the casting film 70 was peeled as the wet film 75 from the casting belt 85, and dried in the transporting area 77 and the tenter device 78. Thus the film 76 was obtained. Thereafter, the film 76 was fed into the drying chamber 80 in which the film 76 was lapped on many rollers 105. In the drying chamber 80, while the film 76 was transported, the drying thereof was made enough. At last, the film 76 was wound up around the winding roller 110 in the winding chamber 82. According to the product film 76, the content of remaining solvent was 0.4 wt. %, and the thickness was 80 μm. The product film has a first layer which is originally the contact layer of the casting film 70, a second layer which is originally the main layer, and the third layer which is originally the exposure layer. In this embodiment, the thickness t2′ of the second layer is not controlled especially. Since the casting volume was adjusted as described above, the film thickness of the produced film 76 after the stretch was controlled so as to be 80 μm, and the values t1′, t3′ were respectively 3 μm and 20 μm.

In Example 1, the flow rate V1 of the of each first-third liquid 52a, 55a, 58a and the flow rate V2 of the casting dope in each feed pipe L1-L3 satisfied a formula, V1/V2=3, and a shear rate of the casting dope flowing each feed pipe L1-L3 was 1.3 (sec⁻¹). The Reynolds number was 5. Further, each tube 60 had the slit outlet 69, and the number of the element was 42. The distance D from the outlet to the static mixer was 10 mm.

### EXAMPLE 2

The amount of the solvent in the third liquid 58a was adjusted, such that the viscosity η3 of the third dope 122 might be 15 Pa·s, and the percentage X of solid compound was 17 wt. %. The thickness of each layer in the product film 76 was changed as shown in Table 1. Other conditions were the same as Example 1.

### EXAMPLE 3

The amount of the solvent in the third liquid 58a was adjusted, such that the viscosity η3 of the third dope 122 might be 20 Pa·s, and the percentage X of solid compound was 19 wt. %. The thickness of each layer in the product film 76 was changed as shown in Table 1. The total film thickness of the casting film 70 was 100 μm. Other conditions were the same as Example 1.

### EXAMPLE 4

The amount of the solvent in the third liquid 58a was adjusted, such that the viscosity η3 of the third dope 122 might be 50 Pa·s, and the percentage X of solid compound was 20 wt. %. Other conditions were the same as Example 1.

### EXAMPLE 5

Instead of the tube having the slit-like outlet, a tube having a circular outlet was used. Other conditions were the same as Example 1.

### EXAMPLE 6

The following compounds are mixed in the dope preparation line 10, such that a cyclic polyolefin dope C may be prepared as the third dope 122 for the exposure layer.

<Production of Cyclic Polyolefin Dope C to
be used as Third Dope for Exposure Layer>

| | | |
|---|---|---|
| Cyclic Polyolefin | 100 | pts. wt. |
| (Norbornene Carboxylic Acid Methyl Ester) | | |
| Dichloromethane (first solvent component) | 370 | pts. wt. |
| Methanol (second solvent component) | 29 | pts. wt. |
| Particles (silicon dioxide, primary particle | 1 | pts. wt. |
| diameter 16 nm; aerosol R972 produced | | |
| by Nippon Aerosil Co. Ltd.) | | |

<Preparation of Cyclic Polyolefin>

First, 100 pts.mass of the norbormene carboxylic acid methyl ester and 100 pts.mass of the purified toluene are fed into a reaction kettle. Then, 25 mmol % of ethylene hexanoate-Ni (in monomer mass) dissolved in toluene, 0.225 mol % of tri(pentafluorophenyl)boron (in monomer mass), and 0.25 mol % of triethylaluminium (in monomer mass) dissolved in toluene were also fed into the reaction kettle. Thereafter, the stirring of the mixture was made to make reaction for 18 hours. After the reaction, the mixture was fed into an excessive ethanol, such that polymer might precipitate. The precipitated polymer was refined and dried. Thus the obtained polymer was the cyclic polyolefin.

As in Example 1, the cyclic polyolefin dope was prepared as in followings in the dope production line 10 of FIG. 1. At first, an adequate amount of the dichloromethane was fed from the solvent tank 11 to the dissolution tank 15, and thereafter an adequate amount of the methanol was fed from the methanol tank to the dissolution tank 15. Then the cyclic polyolefin was fed from the hopper 13 to the dissolution tank 15. Thereafter, the stirring of the cyclic polyolefin, the dichloromethane and the methanol was made in the dissolution tank 15, such that the mixture 17 might be obtained. Then the defoaming processing of the mixture was made by the ultrasonic irradiation, and thereafter, the impurities were trapped by the filtrating with use of the second filtration device 26. After the filtration, the mixture 17 was fed into the stock tank 28 and stored as the primary dope 20 therein.

Then part of the primary dope 20 was fed into the third feed line L3. Then the pump P8 was driven to feed the third liquid 58a from the second tank 58 to the second feed line L2. The primary dope 20 and the third liquid 58a are mixed and stirred by the static mixer 59. Thus the third dope for forming the exposure layer is prepared. The viscosity η3 of the third dope 122 was 20 Pa·s.

The following compounds are mixed in the dope preparation line 10, such that a cyclic polyolefin dope D may be prepared as the first dope 120 for the contact layer and the second dope 121 for the main layer. The viscosity η1, η2 of the first and second dopes 120, 121 was 65 Pa·s, and the content X was 25 wt. %.

<Production of Cyclic Polyolefin Dope D to be used as First
Dope for Contact Layer & Second Dope for Main Layer>

| | | |
|---|---|---|
| Cyclic Polyolefin | 100 | pts. wt. |
| (Norbornene Carboxylic Acid Methyl Ester) | | |
| Dichloromethane (first solvent component) | 276 | pts. wt. |
| Methanol (second solvent component) | 23 | pts. wt. |
| Particles (silicon dioxide, primary particle | 1 | pts. wt. |
| diameter 16 nm; aerosol R972 produced | | |
| by Nippon Aerosil Co. Ltd.) | | |

Then the first-third dopes 120-122 produced from the cyclic polyolefin were fed in the film production line 50. First, the co-casting of the first-third dopes 120-122 from the casting die 89 onto the casting belt 85 was made so as to form the casting film 70 having a three layer structure of the main layer 121a, the contact layer 120a and the exposure layer 122a.

At the casting, the casting volume of each dope was adjusted such that the condition of t1≦t3≦t2 may be satisfied. The film thickness of the casting film 70 was controlled so as to be 80 μm after the stretch. However, the casting volume of each first and second dope 120, 121 is adjusted, such that the thickness t1′ of the first layer in the product film 76 was 3 μm and the thickness t3′ of the third layer was 10 μm.

Then the casting film 70 was peeled as the wet film 75 from the casting belt 85, and dried in the transporting area 77 and the tenter device 78. Thus the film 76 was obtained. Thereafter, the film 76 was fed into the drying chamber 80 in which the film 76 was lapped on the rollers 105. In the drying chamber 80, while the film 76 was transported, the drying thereof was made enough. At last, the film 76 was wound up around the winding roller 110 in the winding chamber 82. According to the product film 76, the content of remaining solvent was 0.4 wt. %, and the thickness was 80 μm.

### EXAMPLE 7

The amount of the solvent in the third liquid 58a was adjusted, such that the viscosity η3 and the content X of the third dope 122 might be controlled. The thickness t3′ of the third layer was 10 μm. Other conditions were the same as Example 4.

### EXAMPLE 8

The amount of the solvent in the third liquid 58a was adjusted, such that the viscosity η3 and the content X of the third dope 122 might be controlled. The thickness t3′ of the third layer was 25 μm. Other conditions were the same as Example 4.

### EXAMPLE 9

The amount of the solvent in the third liquid 58a was adjusted, such that the viscosity η3 of the third dope 122 might be 65 Pa·s, and the percentage X of solid compound was 25 wt. %. The thickness t3′ of the third layer was 10 μm. Other conditions were the same as Example 4.

### EXAMPLE 10

The amount of the solvent in the third liquid 58a was adjusted, such that the viscosity η3 of the third dope 122 might be 10 Pa·s, and the percentage X of solid compound was 19 wt. %. The thickness t3′ of the third layer was 25 μm. Other conditions were the same as Example 4.

[Comparison 1]

The amount of the solvent in the third liquid 58a was adjusted, such that the viscosity η3 of the third dope 122 might be 4 Pa·s, and the content X of solid compound in the third dope 122 was 14 wt. %. The thickness of each layer in the casting film was changed as shown in Table 1. Other conditions were the same as Example 1.

[Comparison 2]

The amount of the solvent in the third liquid 58a was adjusted, such that the viscosity η3 of the third dope 122 might be 10 Pa·s, and the content X of solid compound in the third dope 122 was 17 wt. %. The thickness of each layer in the casting film is changed as shown in Table 1. Other conditions were the same as Example 1.

[Comparison 3]

The amount of the solvent in the third liquid 58a was adjusted, such that the viscosity η3 of the third dope 122 might be 20 Pa·s, and the content X of solid compound in the third dope 122 was 21 wt. %. The total film thickness of the casting film 70 was 80 μm. The thickness t3′ of the third layer was 1 μm. Other conditions were the same as Example 4.

In the examples and comparisons, the peelability of the casting film from the support, the planability of the produced film were estimated in the following manners.

[Estimation of Peelability of Casting Film]

The surface of the casting film was observed with eyes after the peeling of the casting film. If part of the casting film did not remain on the surfaces and the productivity of the casting film did not become lower, the estimation is B (positive). If part of the casting film remained on the surfaces and the produce film can be used, the estimation is C. If part of the casting film remained on the surfaces and the productivity of the casting film became lower, the estimation is N.

[Smoothness of Film]

The film surface of the produced film was observed with eyes. If there was surface unevenness and the film surface was smooth, the estimation was A (excellent). If there was slight surface unevenness and the produced film was usable, the estimation is B (usable). If there was surface unevenness and it was not adequate to use the produced film, the estimation was C (considerable for use). If there was surface unevenness too much and the produced film couldn't be used, the estimation was N (negative).

In Table 1, the conditions for preparation of the third dope for the exposure layer in the above examples and comparisons, and the results will be shown.

TABLE 1

| | Ex. 1 | Ex. 2 | Ex. 3 | Ex. 4 | Ex. 5 | Co. 1 | Co. 2 |
|---|---|---|---|---|---|---|---|
| η3 (Pa · s) | 15 | 10 | 20 | 50 | 15 | 4 | 10 |
| X (%) | 18 | 17 | 19 | 23 | 18 | 14 | 17 |
| t1′ (μm) | 3 | 3 | 3 | 3 | 3 | 3 | 3 |
| t2′ (μm) | 57 | 67 | 87 | 57 | 57 | 37 | 96 |
| t3′ (μm) | 20 | 10 | 10 | 20 | 20 | 40 | 1 |
| FT (μm) | 80 | 80 | 100 | 80 | 80 | 80 | 100 |
| Peelability | B | B | B | B | N | N | B |
| Smoothness | A | A | B | B | B | C | N |

TABLE 2

| | Ex. 6 | Ex. 7 | Ex. 8 | Ex. 9 | Ex. 10 | Co. 3 |
|---|---|---|---|---|---|---|
| η3 (Pa · s) | 14 | 10 | 23 | 65 | 10 | 20 |
| X (%) | 20 | 19 | 21 | 25 | 19 | 21 |
| t1′ (μm) | 3 | 3 | 3 | 3 | 3 | 3 |
| t2′ (μm) | 37 | 72 | 72 | 67 | 52 | 76 |
| t3′ (μm) | 10 | 5 | 5 | 10 | 25 | 1 |
| FT (μm) | 80 | 80 | 80 | 80 | 80 | 80 |
| Peelability | B | B | B | B | C | B |
| Smoothness | A | A | B | C | B | N |

Tₜₒₜₐₗ (μm): total film thickness of casting film
t1 (μm): thickness of contact layer in casting film
t2 (μm): thickness of main layer in casting film
t3 (μm): thickness of exposure layer in casting film
FT (μm): thickness of produced polymer film

As the result of the above examples and comparisons, the produced film in the present invention is excellent for use as the optical compensation film in the liquid crystal display. Further, the peelability of the casting film from the support is good. Therefore, the polymer film adequate for the optical use can be produced with high productivity, as described above.

Various changes and modifications are possible in the present invention and may be understood to be within the present invention.

1. A production method of a polymer film, comprising steps of:
adding an additive to a primary dope as a mixture of a polymer and an organic solvent so as to prepare three sorts of dopes;
casting said dopes on a moving support, so as to form a casting film having three layers superimposed, said three layers being a first layer of thickness t1 (μm), a second layer of thickness t2 (μm) and an third layer of thickness t3 (μm), at least one of said thickness t1, t2 and t3 being different, a condition t1≦t3≦t2 being satisfied;
peeling from said support said casting film as a wet film containing said organic solvent;
clipping both side edge portions of said wet film by a clipping member;
stretching said wet film in a widthwise direction by moving said clipping member; and
drying said wet film during said stretching such that said polymer film may be obtained.

2. A production method according to claim 1, wherein a percentage of said thickness t3 of said third layer to a total thickness of said casting film is in the range of 3% to 40%.

3. A production method according to claim 1, wherein said dopes for forming said first-third layers are respectively a first dope, a second dope and a third dope, and a condition η3≦η1≦η2 is satisfied if viscosities of said first, second and third dopes are respectively described as η1 (Pa·s), η2 (Pa·s) and η3 (Pa·s).

4. A production method according to claim 1, wherein said polymer is a cellulose acylate whose polymerization degree is in the range of 250 and 450.

5. A production method according to claim 4, wherein said viscosity η3 of said third dope satisfies 5 Pa·s≦η3≦30 Pa·s.

6. A production method according to claim 1, wherein a mass A (g) of solid compound contained in said third dope and a mass B (g) of said organic solvent satisfy a formula 16≦[(A−B)/A]×100≦21.

7. A production method described in claim 1,
wherein said primary dope is fed in a pipe,
wherein said additive is added to said primary dope through a tube connected to said pipe; and
wherein a stirring of a mixture of said primary dope and said additive is made by a static mixer provided in said pipe.

8. A production method described in claim 7, wherein said tube includes at an end thereof a slit outlet extending in a diameter direction of said pipe.

9. A production method described in claim 8, wherein a length of said slit is in the range of 20% to 80% of an inner diameter of said pipe.

10. A production method described in claim 8, wherein a clearance C of said slit is at least 0.1 mm and at most one tenth of an inner diameter of said pipe.

11. A production method described in claim 8, wherein a distance D from said additive to said inline mixer is in the range of 1 mm to 250 mm.

12. A production method described in claim 8, wherein a current speed V1 of said additive flowing in said tube and a current speed V2 of said primary dope flowing in said pipe satisfy a condition, 1≦V1/V2≦5.

13. A production method described in claim 1, wherein said casting is a co-casting or a sequential casting.
